(19) United States
(12) Patent Application Publication
(10) Pub. No.: US 2014/0068400 A1
(43) Pub. Date: Mar. 6, 2014

(54) Content Version Control

(71) Applicants: David Gulezian, San Francisco, CA (US); Richard Turner Barker, Piedmont, CA (US); Nathaniel Anthony Fast, Santa Rosa, CA (US)

(72) Inventors: David Gulezian, San Francisco, CA (US); Richard Turner Barker, Piedmont, CA (US); Nathaniel Anthony Fast, Santa Rosa, CA (US)

(21) Appl. No.: 13/610,761

(22) Filed: Sep. 11, 2012

Related U.S. Application Data
(60) Provisional application No. 61/694,719, filed on Aug. 29, 2012.

(51) Int. Cl. G06F 17/00; G06F 17/24

(52) U.S. Cl. 715/202; 715/255

(57) ABSTRACT

A technique involves allowing use of content only if the content has been approved for the use. The content can be stored in a universal content format to facilitate cross-platform approval in a single approval transaction. The content can include granular content items incorporated into larger documents. In a specific implementation, it is possible to grant approval for one or more of the granular content items.

### CROSS-REFERENCE TO RELATED APPLICATIONS

This application claims priority to U.S. Provisional Patent Application No. 61/694,719, filed Aug. 29, 2012, entitled “CONTENT VERSION CONTROL,” which is incorporated by reference herein.

### BACKGROUND

Improving control of content versions is an area of ongoing research and development. An area in which content control is of particular importance is in regulated industries, such as the pharmaceutical industry, where what is said about a product can have repercussions with regulatory agencies. However, content version control is an issue that arises in a number of different fields, any of which could benefit by new techniques designed to offer greater control over content and messaging.

### SUMMARY

A technique involves allowing use of content only if the content has been approved for the use. The content can be stored in a universal content format to facilitate cross-platform approval in a single approval transaction. The content can include granular content items incorporated into larger documents. In a specific implementation, it is possible to grant approval for one or more of the granular content items.

A system making use of a universal content format can import content from relevant parties associated with an organization, group, association, or other entity, and allow other parties to edit or display the content in accordance with their roles within the organization. Systems that use the universal content format have a variety of advantages.

### BRIEF DESCRIPTION OF THE DRAWINGS

FIG. 1 depicts a diagram of an example of a system for preventing a presenter from going off-label.

FIG. 2 depicts a diagram of an example of a content version control system with an interactive presentation builder.

FIG. 3 depicts a diagram of an example of an administrative engine.

FIG. 4 depicts a diagram of an example of a universal slide data structure.

FIG. 5 depicts a flowchart of an example of a method for transcoding a document to a universal format structure.

FIG. 6 depicts a flowchart of an example of a method for granular modification of approval-controlled content.

FIG. 7 depicts a diagram of an example of a universal format-based speaker portal management system.

FIG. 8 depicts a flowchart of an example of a process for version control.

### DETAILED DESCRIPTION

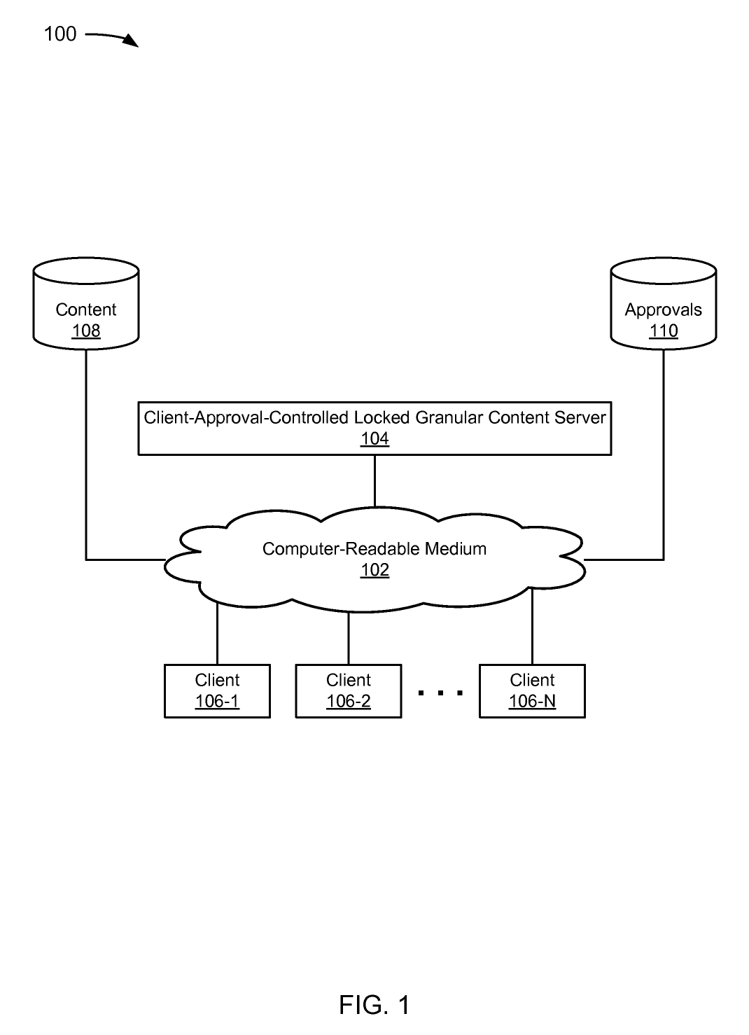

FIG. 1 depicts a diagram 100 of an example of a system for preventing a presenter from going off-label. The diagram 100 includes a computer-readable medium 102, a client-approval-controlled locked granular content server 104, clients 106-1 to 106-N (collectively, the clients 106), a content datastore 108, and an approvals datastore 110.

In the example of FIG. 1, the computer-readable medium 102 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 102 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 102 can include a data path, such as a bus, in a computer. In such an implementation, one or more of the components illustrated in the example of FIG. 1 can be implemented on the same machine.

In the example of FIG. 1, the client-approval-controlled locked granular content server 104 is coupled to the computer-readable medium 102. A server is a computer program that serves requests from other computer programs, the clients. A server can be implemented as an engine. Engines, as described below and in this paper generally, refer to computer-readable media coupled to a processor. The computer-readable media have data, including executable files, that the processor can use to transform the data and create new data. An engine can include a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium for implementation in an engine is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The functionality of the client-approval-controlled locked granular content server 104 is described in greater detail below.

In a specific implementation, the client-approval-controlled locked granular content server 104 can be implemented on a device that includes an administration engine, an authoring engine, a reporting engine, a versioning engine, and/or other engines that facilitate or are otherwise associated with content management or server operation.

In the example of FIG. 1, the clients 106 are coupled to the computer-readable medium 102. Clients are computer programs that makes requests of a computer program that provides services. A client can be implemented as an engine. The clients 106 depicted in the example of FIG. 1 are intended to represent clients of the server 104, but it should be understood that a client is a defined role for a given situation, and a device could include a client of a specific server and a server for a specific client simultaneously. Thus, the clients 106 can run on a device that has other clients or servers not relevant to the examples in which the clients 106 are discussed.

In a specific implementation, the clients 106 can be implemented on a device, such as a tablet, smart phone, or other computing device, that includes a user content datastore and presentation plugins. The device can be coupled to a device management system (not shown) that can include, for example, a content datastore, a device catalog, a synchronization services engine, a secure site SSL over sockets engine, or the like. Depending upon the implementation, the device can be referred to as a client of the device management system (though the clients 106 that are also on the devices can instead or in addition have a client-server relationship with the client-approval-controlled locked granular content server 104, potentially meaning the device has at least two “clients”). To make FIG. 1 more generally applicable, the device management system is omitted in favor of conceptually distinct content and approvals datastores.

In the example of FIG. 1, the content datastore 108 is coupled to the computer-readable medium 102. The content datastore 108 and other datastores described in this paper, can be implemented, for example, as software embodied in a physical computer-readable medium on a general- or specific-purpose machine, in firmware, in hardware, in a combination thereof, or in an applicable known or convenient device or system. Datastores described in this paper are intended, if applicable, to include any organization of data, including tables, comma-separated values (CSV) files, traditional databases (e.g., SQL), or other known or convenient organizational formats.

In an example of a system where a datastore is implemented as a database, a database management system (DBMS) can be used to manage the datastore. In such a case, the DBMS may be thought of as part of the datastore or as part of another applicable depicted component, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the datastores described in this paper could presumably be implemented as database servers. It should be noted that there are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

The content datastore 108 includes content that is served by the client-approval-controlled locked granular content server 104 to one or more of the clients 106. The content datastore 108 or a portion thereof can be implemented on the same device as the server 104 or the content datastore 108 can be implemented on a device distinct from the device on which the server 104 is implemented. In a specific implementation, the content datastore 108 or a portion thereof is implemented on the same device as one or more of the clients 106.

In the example of FIG. 1, the approvals datastore 110 is coupled to the computer-readable medium 102. The approvals datastore 110 may or may not be part of the same logical or physical datastore as the content datastore 108, but is depicted distinctly for conceptual reasons. The approvals datastore 110 includes approvals for items of content in the content datastore 108. The approvals can be for content that is stored in a universal format. The approvals can be for decks, templates, slides, or on an even more granular level. Advantageously, approvals can be for specific versions of content, which are locked to prevent alteration of the version.

An approval data structure in the approvals datastore 110 can include approver data, such as an identifier of a user, role, or group that granted the approval, the data an approval was granted, or the like. The approval data structure can also include an indication of the granularity of approval. For example, approval could be for a fixed deck that cannot be modified (or cannot be modified without invalidating the fixed deck approval indicator) or a flexible deck with approvals of slides or slide buckets on a more granular level.

In the example of FIG. 1, the rights datastore 112 is coupled to the computer-readable medium 102. The rights datastore 112 may or may not be part of the same logical or physical datastore as the content datastore 108 and/or the approvals datastore 110, but is depicted distinctly for conceptual reasons. The rights datastore 112 includes indications of rights for items of content in the content datastore 108. The rights can be for read, write, view, or some other form of rights (e.g., to create new content items, to delete content items, etc.). The rights can be granted on an individual or group basis (e.g., by grouping individuals explicitly, or implicitly based upon role as identified within a business ontology or in some other indirect fashion). Advantageously, granular rights configurations enable the relevant parties to have rights to only content items over which they should have control or access.

Advantageously, using the system illustrated by way of example in FIG. 1, presenters can be prevented from going off-label. For example, a deck could be linked to a Medical Regulatory Board (MedReg) number to represent a form of approval. In such an implementation, the content can be referred to as “MedReg-controlled content.” A user of the system would know whether content that they are using is MedReg-controlled, and make decisions accordingly. A Medical Regulatory Board typically decides on MedReg approval in accordance with legal requirements.

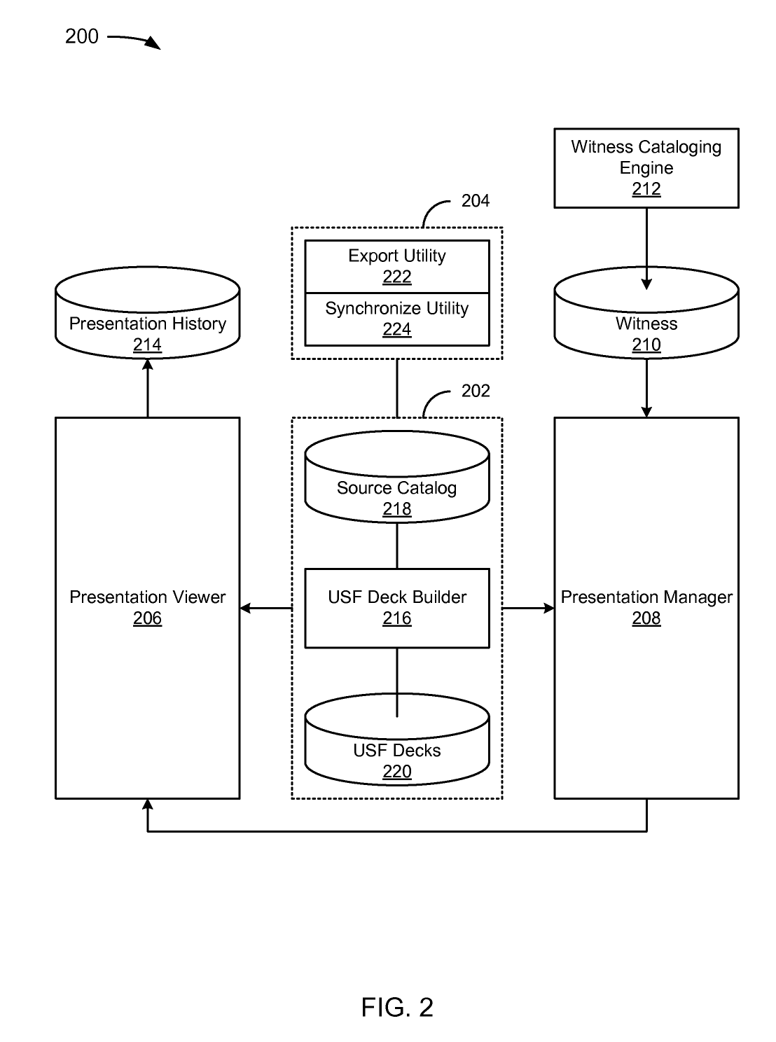

FIG. 2 depicts a diagram 200 of an example of a content version control system with an interactive presentation builder. In the example of FIG. 2, the diagram 200 includes a presentation building engine 202, a utility engine 204, a presentation viewer 206, a presentation manager 208, a witness datastore 210, a witness cataloging engine 212, and a presentation history 214. The example of FIG. 2 is intended to represent what can be referred to as a presenter (or speaker) portal for a user. A user can login through a device local to the user through a computer-readable medium (not shown) coupled to the presenter portal. The utility engine 204 is coupled to presentation materials in multiple formats (not shown) and/or hosted service (not shown) through a computer-readable medium (not shown), which may or may not be the same as the computer-readable medium through which the user is coupled to the presenter portal.

In the example of FIG. 2, the presentation building engine 202 includes a universal slide format (USF) deck builder 216, a source catalog datastore 218, and a USF decks datastore 220. The presentation building engine 202 can be implemented on a known or convenient computer system. Only one presentation building engine 202 is illustrated in FIG. 2, but it should be understood that specific implementations could have multiple servers. Moreover, partial functionality might be provided by a first device and partial functionality might be provided by a second device, where together the first and second devices provide the full functionality attributed to the presentation building engine 202.

In the example of FIG. 2, the USF deck builder 216 can be implemented as an engine and can, accordingly, be referred to as a “USF deck building engine.” In operation, the USF deck builder 216 can receive input from a user (not shown), the source catalog 218, and the utility engine 204. These inputs are used to generate a deck that the USF deck builder 216 stores in the USF decks datastore 220. Techniques used to build a presentation are described later. In alternative implementations, other techniques described in this paper are used in association with a deck builder that does not utilize a USF.

The source catalog 218 can be implemented as a datastore and can, accordingly, be referred to as a “source datastore.”

In the example of FIG. 2, the utility engine 204 is coupled to the presentation building engine 202. The utility engine 204 includes an export utility 222 and a synchronize utility 224, both of which can be implemented as engines. The export utility 222 can export decks (or data associated with decks) from the USF decks datastore 220 in a variety of different formats. The synchronize utility 224 can import decks (or data associated with decks) having a variety of different formats and synchronize the decks with the USF.

In the example of FIG. 2, the presentation viewer 206 is coupled to the presentation building engine 202. When a deck is being built or after the deck is complete, the deck or a portion thereof can be presented using the presentation viewer 206.

In the example of FIG. 2, the presentation manager 208 is coupled to the presentation building engine 202. Presentation management can include speaker assistance, calendaring events, and other actions associated with presenting a deck. In a specific implementation, the presentation manager 208 controls use of MedReg-controlled content in applicable situations. In other implementations, the presentation manager 208 can control use of other types of content.

In the example of FIG. 2, the witness datastore 210 is coupled to the presentation manager 208. The witness datastore 210 can be populated by the witness cataloging engine 212. Ultimately, the relevant witnesses are associated with the relevant decks by the presentation manager 208. When the presentation viewer 206 is used in association with a presentation of a deck, the presentation manager 208 provides input to the presentation viewer 206 and the presentation viewer 206 stores some or all of the associated data, such as the relevant deck and witnesses, in the presentation history datastore 214.

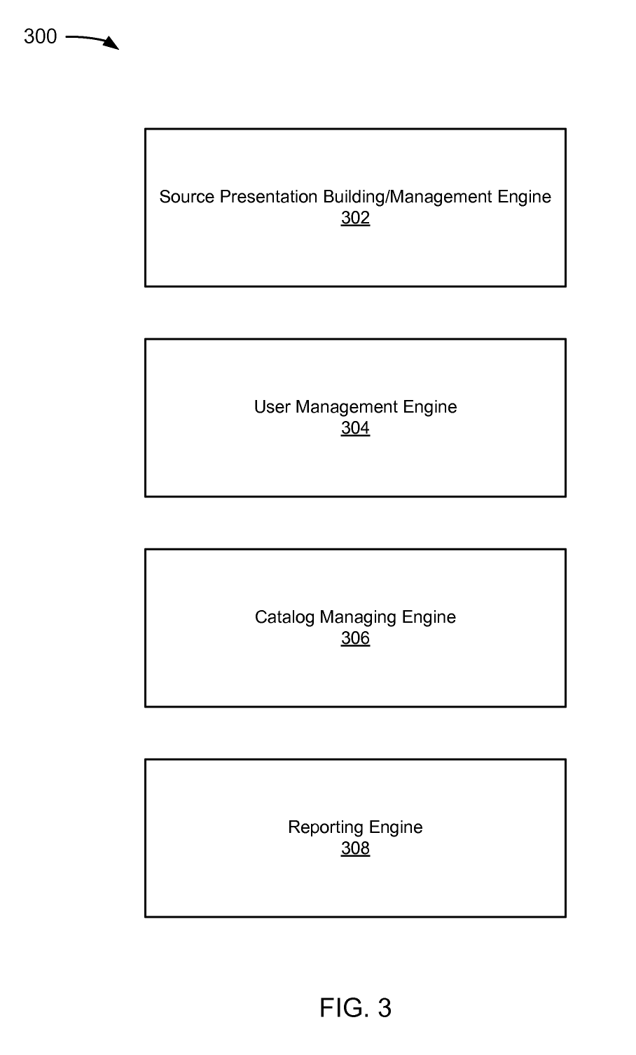

FIG. 3 depicts a diagram 300 of an example of an administrative engine. The diagram 300 includes a source presentation building/management engine 302, a user management engine 304, a catalog management engine 306, and a reporting engine 308. In the example of FIG. 3, the source presentation builder/manager 302 can include an upload engine, an annotation engine, a sequence engine, a version engine, and a presentation slide create/read/update/delete (CRUD) engine. The user management engine 304 can be implemented as a CRUD engine for users. The catalog management engine 306 can be used to manage presentation source datastores, generated decks, or presenter witness catalogs. The reporting engine 308 can report on account administration, presentation scheduling, or the like.

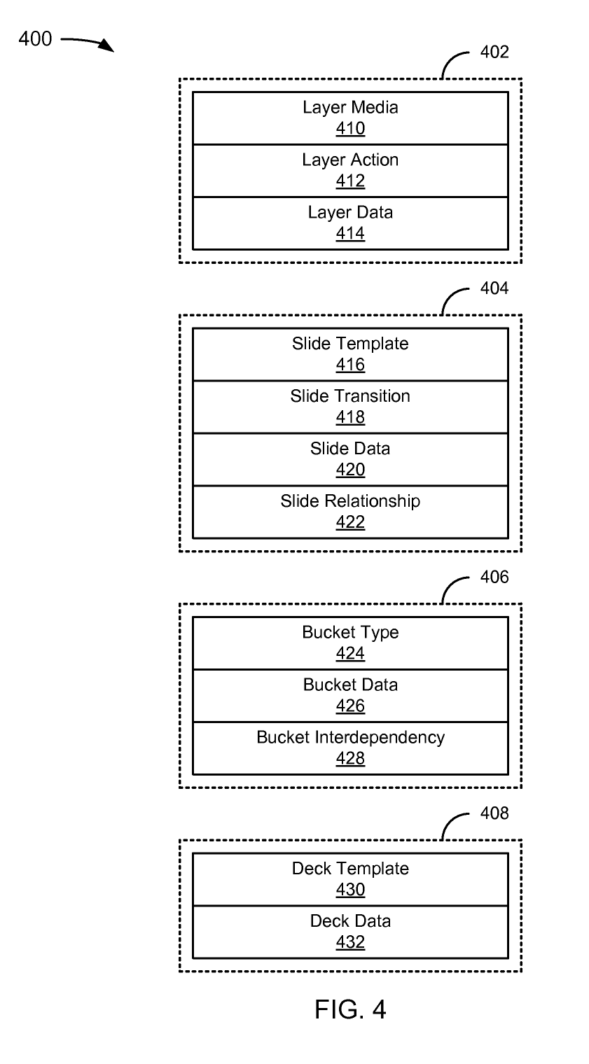

FIG. 4 depicts a diagram 400 of an example of a universal content data structure. In a specific implementation, the universal content data structure has an explicit identifier (not shown) that uniquely refers to an instance of the universal content data structure. The explicit identifier can be in the form of a human-readable name for the relevant instance or a machine-readable name or actual or relative location identifier for the relevant instance. In the example of FIG. 4, the diagram 400 includes a layer super-structure 402, a slide super-structure 404, a group super-structure 406, and a deck super-structure 408. The term “super-structure” is used to cover a category of items that may or may not be referred to in a specific implementation as a record, object, or some other collection of items. In a specific implementation, each of the super-structures 402-408 has an explicit identifier (not shown) that uniquely refers to instances of the super-structures 402-408. Alternatively, the super-structures 402-408 may be conceptual organizations of data that do not have explicit identifiers.

In the example of FIG. 4, the layer super-structure 402 includes a layer media structure 410, a layer action structure 412, and a layer data structure 414. The layer media structure 410 can include image, video, text, mask, or the like.

The layer action structure 412 can include actions that can be taken on layer media, such as slide, fade, dissolve, or the like. Applicable actions can vary depending upon the type of content that is being displayed (e.g., image, video, and text may have slightly or significantly different applicable actions). Applicable actions can be added as needed or desired. The actions can be stored as pointers, variables, functions, methods (e.g., within an object), or in some other applicable manner. In a specific implementation that relates to the visual animation of layer media, the layer action structure 412 can be referred to as including a layer animation structure. Colloquial distinctions between media and animation can be blurred in some cases. For example, an item of content, such as a bullet point, could be animated to fly into a slide with a “whooshing” sound. The bullet point would obviously be characterized as media, the animation flying the bullet point into the slide animation, but reasonable minds could differ about whether the “whooshing” sound is media or animation. For the purposes of this paper, the former definition is assumed. That is, the media file that contains the “whooshing” sound is defined as layer media.

The layer data structure 414 can include a Z-ordered set of layers. The layer data structure 414 includes data about each layer in the appropriate order.

In the example of FIG. 4, the slide super-structure 404 includes a slide template structure 416, a slide transition structure 418, a slide data structure 420, and a slide relationship structure 422. “Slide” is a convenient term to describe a unit of display of content, but other terms can be used in various implementations, such as a page, a window, or the like. The slide template structure 416 can include a layout basis for a slide.

The slide transition structure 418 can include data sufficient to determine how a slide transitions to a next slide. The transition can depend upon a transition type, such as standard, video, agenda, or some other descriptor for a type of slide.

The slide data structure 420 can include notes for a speaker or master of ceremonies or slide descriptions, such as leaf node, title, ID, version, or the like that are descriptive of a slide. The slide data structure 420 includes data that essentially points to an entire, complete slide, as opposed to data that is directed to a more granular content item within a given slide.

The slide relationship structure 422 can include data about how slides are ordered with relation to one another. In a specific implementation, this data can be referred to as “n of X” data to represent how a specific slide, n, falls within the organization of all slides, X, in a deck. Depending on the technology, a slide could have a more complex relationship than “n of X,” such as when the slides are essentially in a tree with multiple conditional branches. However, it is expected that, due to the nature of presentations in general, the “n of X” relationship may be adequate, with branches being treated as exceptions.

In the example of FIG. 4, the group super-structure 406 includes a bucket type structure 424, a bucket data structure 426, and a bucket interdependency structure 428. “Bucket” is a convenient term to describe a set of slides. The bucket type structure 424 can identify a set of rules applicable to the bucket. Bucket types can include optional (the slides can be removed, if desired), permutable (the slides can be presented in any order), following (the slides must follow one another in an indicated order), grouped (the slides must be presented together), locked (the slides must be presented together in a specific order), to name several examples. The bucket type can be indicative of other use rules related to a given bucket.

The bucket data structure 426 can include data about a bucket. In order to enable interdependency between buckets, each bucket must be identifiable to enable ordering within a deck. Thus, the bucket data structure 426 will generally at least include a bucket identifier or address.

The bucket interdependency structure 428 can include a set of rules and fields related to how slides can be presented with respect to one another. Bucket interdependency can include locked (one bucket must immediately follow another bucket), following (one bucket must follow another bucket), flexible (either bucket must follow the other), none (a bucket has no interdependencies and can be deleted if desired), to name several examples. In a specific implementation, the interdependency data is associated with approvals, with deviations from the interdependencies resulting in the approval being rescinded (assuming the system even allows users to deviate).

In the example of FIG. 4, the deck super-structure 408 includes a deck template structure 428 and a deck data structure 430. “Deck” is a convenient term to describe a collection of buckets or slides, but other terms can be used in various implementations, such as a document, a directory, a file, or the like. The deck template structure 428 can include a design shared by an entire deck. The deck data structure 430 can include fields such as top node, approval id, version, name, or the like that are descriptive of a deck. In a specific implementation, the approval id is a MedReg Number, which is a useful indicator of a class of approval in some medicine-related industries.

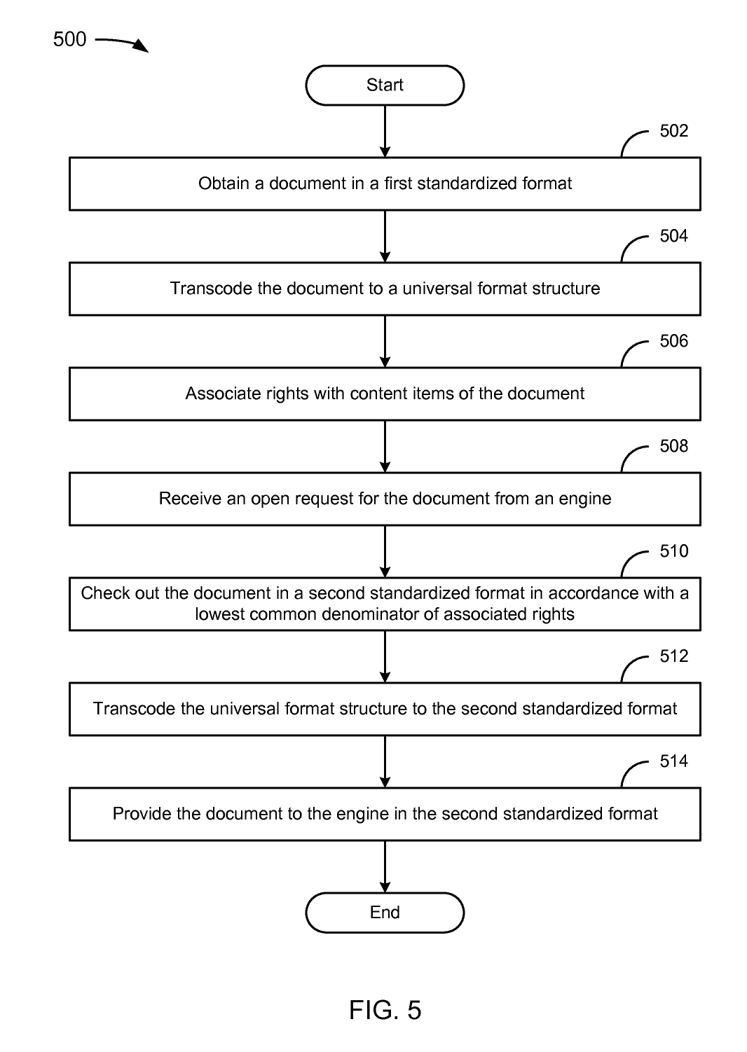

FIG. 5 depicts a flowchart of an example of a method for transcoding a document to a universal format structure. The example of FIG. 5 includes serially-arranged modules, but it should be understood that the modules of the flowchart 500 and other flowcharts described in this paper could be reordered and/or arranged for parallel execution, if applicable.

In the example of FIG. 5, the flowchart 500 starts at module 502 obtaining a document in a first standardized format. In a specific implementation, content received in a format that is not standardized is first converted to the first standardized format using an appropriate editor. If content is received in a format that is not known, the system may or may not provide the capability to search for an appropriate editor. What is meant by a standardized format is relatively well-known in the relevant arts, but it should be understood that if a system is capable of extracting data from the format, it can be considered standardized with respect to the system because is at least sufficiently standardized as to allow extraction of data.

In the example of FIG. 5, the flowchart 500 continues to module 504 with transcoding the document to a universal format structure. Transcoding enables users of the system to view and edit the relevant content in a system editor or their preferred editor, if the system allows. User access to the content is based upon rights. The ability to use content for a presentation is based upon content version approval (and rights).

In the example of FIG. 5, the flowchart 500 continues to module 506 with associating rights with content items of the document. The content items can be modified individually in accordance with the rights. Modified content items can be forced to undergo an approval process before enabling the modified content items to be published and/or used in a public and/or private presentation. This results in a content management system that can be referred to as an element management system (EMS) or slide management system (SMS), as opposed to a document management system (DMS). As used in this paper, EMS or SMS is considered to be a larger superset of DMS.

In the example of FIG. 5, the flowchart 500 continues to module 508 with receiving an open request for the document from an engine. The engine can be, for example, a content editor. Different editors are capable of editing different data formats.

In the example of FIG. 5, the flowchart 500 continues to module 510 with checking out the document in the second standardized format in accordance with a lowest common denominator of associated rights. In a specific implementation, a deck is has a MedReg number that applies to the deck on a non-granular level. It may or may not be possible to modify the deck without making the MedReg number inapplicable. In a specific implementation of that, the lowest common denominator of rights is at the deck level. In other implementations, potential presenters may be capable of mixing and matching slides with slide-level approvals. In a specific implementation, the deck resulting from the compilation of slides has an approval number that is the lowest of the various slides. Thus, if a first slide has a first approval and a second slide has a second approval, the deck would have the most restrictive of the two approvals. In a specific implementation, approvals are on a layer or even more granular basis.

In the example of FIG. 5, the flowchart 500 continues to module 512 with transcoding the universal format structure to a second standardized format. The transcoding and checkout (module 510) can be done in reverse order or in parallel.

In the example of FIG. 5, the flowchart 500 continues to module 514 with providing the document to the engine in the second standardized format. The engine can edit the document in the second standardized format and then save back to the system (not shown) for transcoding.

In alternative implementations, known non-standardized or proprietary formats can be used. Depending upon the capabilities of the system, it may or may not be possible to search for an unknown format, find an appropriate program, and convert the unknown format to a known format prior to transcoding (for import) or convert a known format to an unknown format after transcoding (for export).

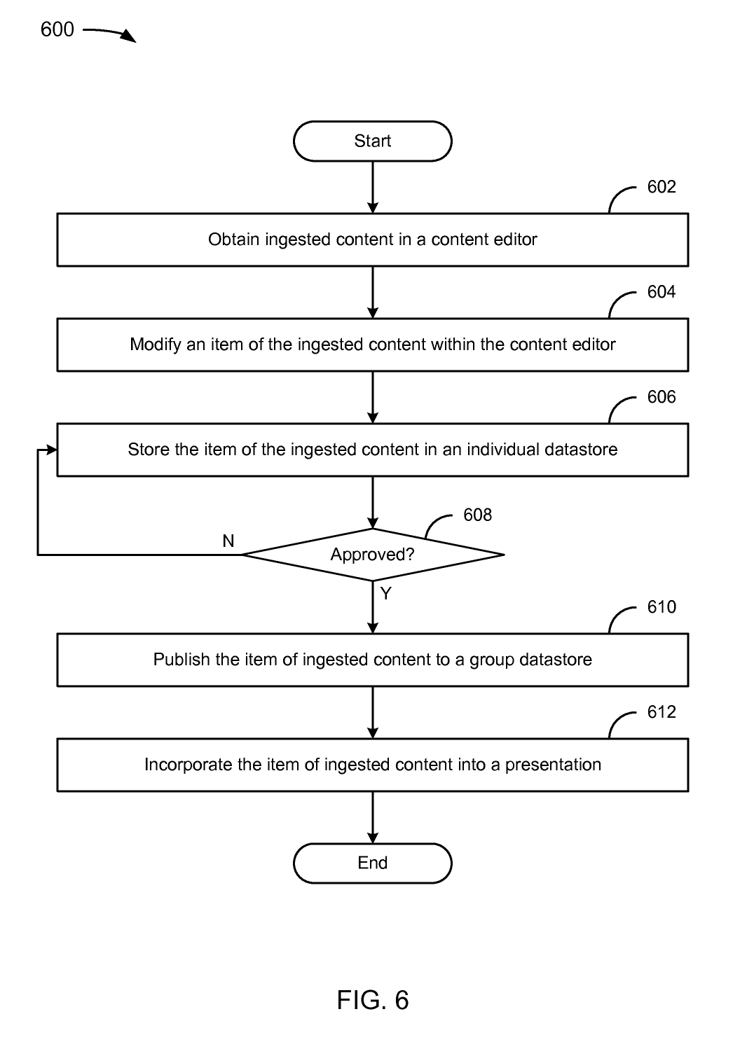

FIG. 6 depicts a flowchart of an example of a method for granular modification of approval-controlled content. In the example of FIG. 6, the flowchart 600 starts at module 602 with obtaining ingested content in a content editor. The ingested content can be a deck or an alternative or more elemental content item.

In the example of FIG. 6, the flowchart 600 continues to module 604 with modifying an item of the ingested content within the content editor. In a specific implementation, when the item of ingested content is modified, it becomes associated with an individual responsible for the modification. The association can involve copying an item to create an individual-associated version of the item. The individual-associated version may or may not be anything more than simply a local copy of the item.

In the example of FIG. 6, the flowchart 600 continues to module 606 with storing the item of the ingested content in an individual datastore. The individual datastore can include content for a specific user. In a specific implementation, the individual datastore is a subset of a larger group (or common) datastore, but the item in the individual datastore is in an approval-pending state until approval is received and it is published to the group datastore. Depending upon configuration, those with rights to the group datastore can have read or write (or other) rights to the item in the individual datastore before it is published.

In the example of FIG. 6, the flowchart 600 continues to decision point 608 where it is determined whether the item of ingested content in the individual datastore has been approved. If it is determined that the item of ingested content in the individual datastore has not been approved (608-N), the flowchart 600 returns to module 606 and continues as described previously. This forms a logical loop that prevents the flowchart from continuing to module 610 until approval has been received. If, on the other hand, it is determined that the item of ingested content has been approved (608-Y), then the flowchart 600 continues to module 610 with publishing the item of ingested content to a group datastore.

In the example of FIG. 6, the flowchart 600 continues to module 612 with incorporating the item of ingested content into a deck. Advantageously, the item of ingested content can automatically be incorporated into decks that have an older version of the item. Because the content is ingested, the item of ingested content can be inserted into various formats, such as VUSF, HTML5, IPA, to name a few, automatically, simultaneously, in parallel, sequentially, serially, on the fly, or in another convenient manner. In a specific implementation, these incorporation techniques can be eliminated, with appropriate configuration, to limit the incorporation of the item of ingested content to explicit or manual incorporation.

Advantageously, users can change an element of, for example, a slide as they desire, then await approval such that the modification is approval-controlled. The granular approval process facilitates percolating the change through the system for all documents that include the content item so that all documents have the approval-controlled content. So, if appropriately configured, it is not necessary to go back to change documents after a content item is changed and old presentations can still be used, as long as the content is appropriately updated beforehand.

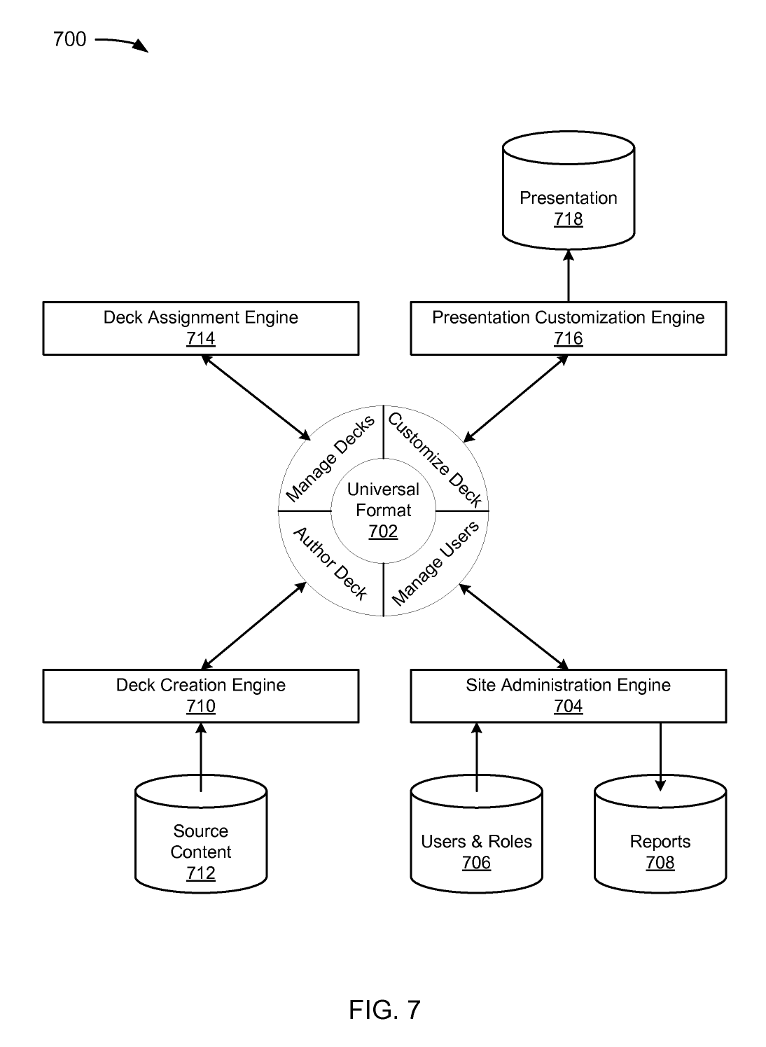

FIG. 7 depicts a diagram 700 of an example of a universal format-based speaker portal management system. The diagram 700 includes a universal format datastore 702, a site management engine 704, a users & roles datastore 706, a reports datastore 708, a deck creation engine 710, a source content datastore 712, a deck assignment engine 714, a presentation customization engine 716, and a presentation datastore 718.

The universal format datastore 702 can include interfaces, which can be implemented as engines, for site administrators, authors, deck managers, and speakers. Universal format data structures stored in the universal format datastore 702 can be implemented as described with reference to FIG. 4 or in some other applicable manner.

The site administration engine 704 manages users for an admin of a content approval-controlled site. A rights management framework can include assigning users, data about which can be maintained in the users & roles datastore 706, to groups or roles within a business ontology. As the site administration engine 704 updates user roles and other user data, the relevant parts of the users & roles datastore 706 can be updated as appropriate. Applicable data can be used in association with the universal format datastore 702 to provide granular content control for users of the system. As a matter of practical use, the site administration engine 704 can also provide reports, which is represented by the arrow from the site administration engine 704 to the reports datastore 708 in the example of FIG. 7.

The deck creation engine 710 can upload content from the source content datastore 712. The uploading of content can include utilizing an import wizard, such as a power point import wizard, to create a basic deck for storage in the universal format datastore 702. The source content datastore 712 can include content stored in a variety of formats, such as text, image, audio, video, multimedia, power point, pdf, or the like.

The deck assignment engine 714 assigns decks to presenters (e.g., speakers). The assignment can entail adjusting rights of presenters in association with content items or decks. The assignment can be manually input by a presenter manager; automated based upon a calendar (and corresponding rule set that grants rights based upon upcoming event dates), roles of users (either in association with a calendar date or the user's role or ranking within their organization), or other criteria and rule sets; or a combination of the two, such as when a presenter manager sets rules to find appropriate speakers and automatically assigns appropriate rights or when an automated procedure identifies seemingly appropriate presenters for approval by the presenter manager. In a specific implementation, in all cases, presentation rights are only granted for content that has been subjected to a prior approval process.

The presentation customization engine 716 is coupled to the universal format datastore 702 and the presentation datastore 718. The presentation datastore 718 can include content stored in a variety of formats, the same as the source content datastore 712, but is more likely, due to the nature of presentations, to be in a pdf, power point, multimedia, or flash enhanced slide deck (ESD) format. The presentation customization engine 716 can include, for example, a deck output wizard capable of providing users with appropriate permissions content in its constituent parts (or as a deck).

Taking advantage of user data from the site administration engine 704, content from the deck creation engine 710, and approval controls from the deck assignment engine, the presentation customization engine can provide approval controlled content to a presenter through a portal. Advantageously, a user can customize a deck and select an appropriate format for the deck. In a specific implementation, the portal includes an online speaker portal. An online speaker portal can include, for example, a calendaring engine, a use-analysis engine, and other engines intended to increase utility of the system. In a specific implementation, the calendaring engine tracks presentations of users (assuming the users utilize a calendaring system, which may or may not be required in a given implementation). Tracking presentations can enable the creation of potentially useful statistics about when and where (geographic or venue-specific) presentations are given, in general or for a specific presenter, role, or group. In a specific implementation, a slide aggregation engine can aggregate slides to results without tracking specific users or members (e.g., by using a zip code where a presentation was given). This enables the effectiveness of the presentation to be weighed in applicable circumstances (e.g., in the area in which the presentation was given). In a specific implementation, the use analysis engine can use timestamps to determine time spent on a given item of content (such as a slide) during a presentation, learn a set of slides that are frequently used in combination, or use some other tool to facilitate gaining a better understanding of when, how, or how often content items are used.

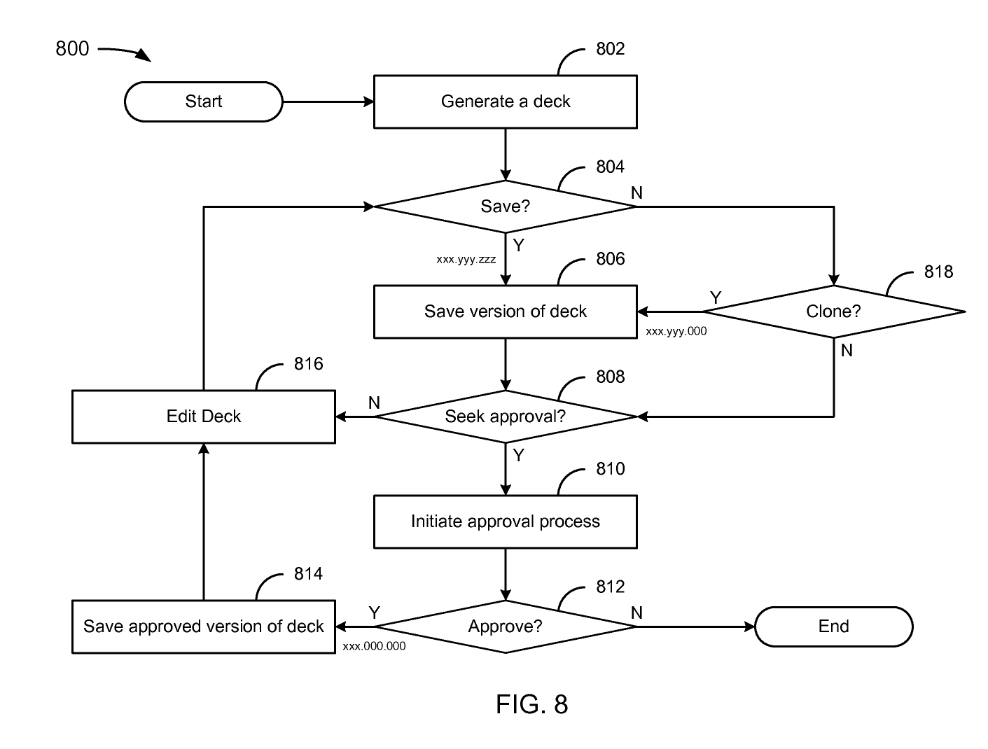

The system of FIG. 7 can be explained in the context of a version control process. FIG. 8 depicts a flowchart 800 of an example of a process for version control. In the example of FIG. 8, the flowchart 800 starts at module 802 with generating a deck. It may be noted that version control can be on a more granular level than a deck, but the deck is used here as a convenient example. The starting deck can be generated by a user opening a new project (e.g., a new power point presentation). The starting deck can also be generated by importing an existing deck. Depending upon the implementation, the first version of the starting deck can be set when the starting deck is first saved in or imported into the system or first saved in or transcoded into a universal format.

In the example of FIG. 8, the flowchart 800 continues to decision point 804 where it is determined whether the deck has been saved. For illustrative consistency throughout this example, versioning has the format xxx.yyy.zzz, where xxx is associated with an approved version of a deck, yyy is associated with a cloned version of a deck, and zzz is associated with a saved version of a deck. By convention, the first version of a deck is 0 (though there is no particular reason why the version could not start at a different number or use a letter instead). Using the format of this example, the first version of the deck would thus be 000.000.000.

If it is determined that the deck has been saved (804-Y), then the flowchart 800 continues to module 806 with saving a version of the deck. Using the example format, the system would increment the zzz subfield of the xxx.yyy.zzz field by 1 when saving a new version of the deck. The xxx and yyy fields would remain unchanged.

In the example of FIG. 8, the flowchart 800 continues to decision point 808 where it is determined whether approval has been sought. In a specific implementation, seeking approval can be explicitly elected by a user, such as by publishing the deck to an appropriate datastore, sending a message requesting approval for the deck, or in some other fashion. In another implementation, approval could be automatic, based upon characteristics of the user (such as rights or role) or characteristics of the content (such as timestamp or file type).

If it is determined that approval has been sought (808-Y), then the flowchart 800 continues to module 810 with initiating an approval process. In a specific implementation, the approval process can be initiated by sending the deck (or a link or identifier thereof) to a user or group, such as a MedReg board. Alternatively or in addition, the deck could be published to a location that is indicative of approval being sought, or a flag could be set in association with the deck indicating the same.

In the example of FIG. 8, the flowchart 800 continues to decision point 812 where it is determined whether the deck is approved. In a specific implementation, approval could be by a user (based upon characteristics of the user granting the user approval authority), a group of users (requiring from one to all “votes” for approval). If the user who seeks approval is able to give approval, the system could at least in theory auto-approve the deck.

If it is determined that the deck has not been approved (812-N), then at least conceptually the flowchart 800 ends. In a specific implementation, users could continue to make edits to the deck after having approval denied (see module 816, below). Alternatively, failure to obtain approval could result in rights being withdrawn (though, at least in theory, additional edits could be made to the deck if rights were reinstated).

If, on the other hand, it is determined that the deck has been approved (812-Y), then the flowchart 800 continues to module 814 where the approved version of the deck is saved. Using the example format, the system would increment the xxx subfield of the xxx.yyy.zzz field by 1 when saving an approved version of the deck. The yyy and zzz subfields would each be reset to 000. In a specific implementation, saving the approved version can entail saving other data, such as a date of publication of the approved version, identification of a user or group responsible for the approval, and other data that is considered to be convenient for the purpose of keeping track of the approval process. Approved versions, particularly in implementations that include content control for presentations, the approved versions of decks can be tracked and analyzed, with deck activity reports being generated to help understand the impact of presentations making use of the approved decks. Such activities can be ongoing even as edits are made to the approved version (the edited versions not necessarily being tracked until they are approved).

In the example of FIG. 8, the flowchart 800 continues to module 816 with editing the deck. Obviously, if the deck were never edited, the flowchart 800 would not get past this module. For illustrative purposes, it is assumed that decks will be edited. After a deck has been edited, the flowchart 800 returns to decision point 804 where it is determined whether the deck has been saved. If the deck has been saved (804-Y), then the flowchart 800 continues as described previously.

If, on the other hand, it is determined that the deck has not been saved (812-N), then the flowchart 800 continues to decision point 818 where it is determined whether the deck has been cloned. If it is determined that the deck has not been cloned (818-N), then the flowchart 800 returns to decision point 808 and continues as described previously.

If, on the other hand, it is determined that the deck has been cloned (818-Y), then the flowchart 800 continues to module 806 and continues as described previously. Using the example format, when saving the cloned version of the deck at module 806, the system would increment the yyy subfield of the xxx.yyy.zzz field by 1 when saving a cloned version of the deck and reset the zzz subfield to 000. The xxx subfield would remain unchanged.

Advantageously, making use of the techniques described, version control can be accomplished. The example provided with reference to FIG. 8 (xxx.yyy.zzz) can be expanded to include more than three subfields. Each higher order subfield can be associated with a higher level of approval in a multiple-approval system. For example, the xxx subfield can be associated with a local level of approval and a higher order subfield can be associated with regional, national, and/or global approvals. A system utilizing this technique can be characterized as utilizing approval-versioned components. The components can be characterized as having multiple subfield version fields, where at least one subfield is an approved version subfield. Also, the components can be characterized as having a plurality of hierarchical approval-versioned subfields.

Lower order subfields can be associated with content items of the deck. For example, a deck xxx.yyy.zzz could have obtained approval, which results in the yyy and zzz subfields each being reset to 000. The buckets that are components of the deck could also have subfields aaa.bbb.ccc, where bbb and ccc are reset to 000 when the deck is approved, and aaa is incremented by 1. Depending upon the characteristics of the bucket, and implementation- and configuration-specific factors, the buckets can be treated as approved buckets when incorporated into a new deck. If the new deck includes buckets that follow their rules of use to be “approved,” the new deck can be approved implicitly, making an explicit approval process unnecessary for decks utilizing approved buckets appropriately.

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C. sec. 212, sixth paragraph, other aspects may likewise be embodied as a means-plus-function claim, or in other forms, such as being embodied in a computer-readable medium. (Any claims intended to be treated under 35 U.S.C. §212, ¶6 will begin with the words “means for”, but use of the term “for” in any other context is not intended to invoke treatment under 35 U.S.C. §212, ¶6.) Accordingly, the applicant reserves the right to add additional claims after filing the application to pursue such additional claim forms for other aspects of the invention.

1. A system comprising:
a presentation building engine;
a utility engine coupled to the presentation building engine;
a presentation viewing engine coupled to the presentation building engine;
a presentation management engine coupled to the presentation building engine;
wherein, in operation,
the utility engine transcodes a deck having one of a set of import formats to a universal slide format (USF);
the presentation building engine modifies the deck;
the presentation viewing engine presents the modified deck to a user;
the presentation management engine controls use of content included in the modified deck.

2. The system of claim 1, wherein the presentation building engine comprises:
a USF deck building engine;
a source catalog datastore coupled to the USF deck builder;
a USF decks datastore coupled to the USF deck builder;
wherein, in operation:
the USF deck building engine receives input from a user, the source catalog datastore, and the utility engine;
the USF deck building engine uses the input to generate a deck that the USF deck building engine stores in the USF decks datastore.

3. The system of claim 1, wherein the utility engine comprises:
an export utility engine to transcode the deck stored in the USF to one of a set of export formats for export from the presentation building engine;
a synchronize utility engine to transcode and synchronize the deck into the USF from the one of the set of import formats for import into the presentation building engine.

4. The system of claim 1, wherein the presentation viewing engine presents controlled content in accordance with the presentation management engine, further comprising a presentation history datastore coupled to the presentation viewing engine, wherein, in operation, the presentation viewing engine stores data associated with a presentation in the presentation history datastore.

5. The system of claim 1, wherein the presentation management engine includes a speaker assistance engine and a calendaring events engine.

6. The system of claim 1, further comprising:
a witness datastore coupled to the presentation manager;
a witness cataloging engine coupled to the witness datastore;
wherein, in operation:
the witness cataloging engine populates the witness datastore;
the presentation manager associates relevant portions of the populated witness datastore with the deck.

7. The system of claim 1, further comprising a client-approval-controlled locked content server, wherein the presentation management engine enforces the client-approval controlled locking of content in association with presentations of the deck.

8. The system of claim 7, further comprising a client-approval-controlled locked granular content server, wherein the utility engine facilitates entry of granular content from an import deck and consolidation of granular content into an export deck from the presentation building engine, and wherein the presentation building engine facilitates use of granular content in the deck.

9. The system of claim 1, further comprising an approvals datastore, wherein, in operation:
the presentation building engine indicates the deck is ready to be approved;
when the approvals datastore is modified to include an approval for the deck, the presentation manager allows use of the deck in presentations.

10. The system of claim 9, wherein approval includes a Medical Regulatory Board (MedReg) approval.

11. The system of claim 1, wherein the USF comprises:
a layer super-structure;
a slide super-structure hierarchically located above the layer super-structure;
a group super-structure hierarchically located above the slide super-structure;
a deck super-structure hierarchically located above the group super-structure.

12. The system of claim 11, wherein the layer super-structure comprises:
a layer media structure;
a layer action structure, hierarchically located above the layer media structure, identifying an action associated with media of the layer media structure;
a layer data structure, hierarchically located above the layer action structure, identifying a Z-ordered set of layers.

13. The system of claim 11, wherein the slide super-structure comprises:
a slide template structure identifying a layout basis for slides;
a slide transition structure, hierarchically located above the slide template structure, identifying how a first slide transitions to a second slide;
a slide data structure, hierarchically located above the slide transition structure, identifying slide characteristics or presentation notes associated with the slide;
a slide relationship structure, hierarchically located above the slide data structure, identifying how the first slide and the second slide are ordered with relation to one another.

14. The system of claim 11, wherein the group super-structure comprises:
a bucket type structure identifying a set of rules applicable to a bucket;
a bucket data structure, hierarchically located above the bucket type structure, identifying the bucket;
a bucket interdependency structure, hierarchically located above the bucket data structure, identifying how slides are presented with respect to one another.

15. The system of claim 11, wherein the deck super-structure comprises:
a deck template structure identifying a design shared by the deck;
a deck data structure, hierarchically located above the deck template structure, identifying the deck and an approval of the deck.

16. The system of claim 1, wherein a presentation customization engine comprises the presentation building engine, the utility engine the presentation viewing engine, and the presentation management engine, further comprising:
a site administration engine to facilitate management of users of the system;
a deck creation engine to facilitate authoring of decks;
a deck assignment engine to facilitate management of decks;
wherein the presentation customization engine is configured to facilitate customization of decks.

17. A method comprising:
obtaining a document in a first standardized format;
transcoding the document to a universal format structure;
associating rights with content items of the document;
receiving an open request for the document from an engine;
checking out the document in a second standardized format in accordance with a lowest common denominator of associated rights;
transcoding the universal format structure to the second standardized;
providing the document to the engine in the second standardized format.

18. The method of claim 17, wherein the engine is a content editor, further comprising:
obtaining ingested content associated with the document in the content editor;
modifying an item of the ingested content within the content editor;
storing the item of ingested content in an individual datastore;
when the item of ingested content in the individual datastore is approved:
publishing the item of ingested content to a group datastore;
incorporating the item of ingested content into the document.

19. The method of claim 17, wherein the document includes a deck, further comprising:
when a save command is received, incrementing a first subfield of a version field of the deck and saving a version of the deck in association with the version field having the incremented first subfield;
when a clone command is received, incrementing a second subfield of the version field, resetting the first subfield, and saving a clone of the deck in association with the version field having the incremented second subfield and the reset first subfield;
when an approval is received for the deck, incrementing a third subfield of the version field, resetting the first subfield and the second subfield, and saving an approved version of the deck in association with the version field having the incremented third subfield and the reset first subfield and second subfield.

20. A system comprising:
a means for obtaining a document in a first standardized format;
a means for transcoding the document to a universal format structure;
a means for associating rights with content items of the document;
a means for receiving an open request for the document from an engine;
a means for checking out the document in a second standardized format in accordance with a lowest common denominator of associated rights;
a means for transcoding the universal format structure to the second standardized;
a means for providing the document to the engine in the second standardized format.
